(19) United States
(12) Patent Application Publication
(10) Pub. No.: US 2006/0039721 A1
(43) Pub. Date: Feb. 23, 2006

(54) Conductive roller and imaging apparatus

(75) Inventors: Yasuro Shiomura, Kanagawa (JP); Yuichiro Mori, Kanagawa (JP); Koji Yamakawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Tokyo, Chuo-ku (JP)

(21) Appl. No.: 10/510,755

(22) PCT Filed: Apr. 11, 2003
(86) PCT No.: PCT/JP03/04667

§ 371 Date: May 5, 2005

(30) Foreign Application Priority Data
Apr. 12, 2002 (JP) 2002-110648

(51) Int. Cl. G03G 15/08

(52) U.S. Cl. 399/286

(57) ABSTRACT

In a conductive roller having a rotation shaft and a conductive elastic layer arranged around the rotation shaft, a resin coating layer including a particle having JIS A hardness of 10-99 and an average particle size of 2-30 μm. An image forming apparatus utilizes the conductive roller mentioned above. Herewith, the image forming apparatus, which has excellent toner carrying property and toner charge property, provides a high quality image with no image unevenness and no image overlapping, and has an excellent durability, and the image forming apparatus installing the above conductive roller are provided.

### TECHNICAL FIELD

The present invention relates to a conductive roller and an image forming apparatus. For more detail, the present invention relates to the conductive roller installed in the image forming apparatus such as a copying machine, a printer and so on, which has excellent toner carrying property and toner charge property, provides a high quality image with no image unevenness and no image overlapping, and has an excellent durability, and the image forming apparatus installing the above conductive roller.

### BACKGROUND ART

Up to now, in an image forming method of an electro-photographic type such as a copying machine, a printer and so on, a pressurized developing method is known such that a one-component resin is supplied to an image forming member such as a photo-conductor and so on in which an electrostatic latent image is maintained and toners adhere to the latent image so as to make a visible image (U.S. Pat. No. 3,152,012, U.S. Pat. No. 3,731,146).

In the pressurized developing method mentioned above, the image formation is performed in such a manner that the toners adhere to the latent image of the image forming member by contacting a toner carrier, on which the toners are supported, to the image forming member (photo-conductor and so on) in which the electrostatic latent image is maintained. Therefore, it is necessary to form the toner carrier mentioned above by a conductive elastic body having conductive properties and elasticity.

That is, in the pressurized developing method mentioned above, as shown for example in FIG. 2, a toner carrier (developing roller) 1 is provided between a toner application roller 5 for supplying the toners and an image forming member (photo-conductor and so on) 6 in which an electrostatic latent image is maintained. Moreover, the toner carrier (developing roller) 1, the image forming member (photo-conductor and so on) 6 and the toner application roller 5 are rotated in an arrow direction in FIG. 2, and thus toners 7 are supplied to a surface of the toner carrier (developing roller) 1 by means of the toner application roller 5. Further, the toners are controlled by a layer forming blade 8 to form a thin film, and then the toner carrier (developing roller) 1 is contacted and rotated with the image forming member (photo-conductor and so on) 6. Further, the toners formed in a shape of the thin film are transferred from the toner carrier (developing roller) 1 to the image forming member (photo-conductor and so on) 6 and adhere to the latent image of the image forming member 6, and the latent image becomes visible.

In the image forming apparatus of the pressurized developing type mentioned above, it is necessary to rotate the toner carrier 1 while the toner carrier 1 is contacted closely to the image forming member 6. Therefore, as shown for example in FIG. 1 illustrating a rough cross section, a conductive elastic layer 3 made of a conductive elastic body in which conductive agents are added for showing a conductive property to a foam or an elastic rubber such as silicon rubber, acrylic nitrile butadiene rubber, ethylene propylene rubber, polyurethane rubber and so on is arranged to an outer surface of a shaft 2 made of a good conductive material such as metal and so on. Further, in order to control charge properties and carrying properties with respect to the toners or to control a friction force between the image forming member and the layer forming blade or to prevent a contamination and so on of the image forming member due to the conductive elastic layer, a coating layer (resin coating layer) 4 made of resin and so on is arranged to a surface of the conductive elastic layer 3.

On the other hand, an image forming method is proposed such that toners supported on a toner carrier are directly flown to an image forming member made of a paper or a paper like member such as OHP sheet and so on through a control electrode having a hole shape.

Moreover, an image forming method is proposed such that nonmagnetic toners having a shape of thin layer is supported to a surface of a toner carrier having a sleeve shape and provided near a photo-conductor in a non-contact state, and the nonmagnetic toners are flown to the photo-conductor so as to be developed. (Japanese Patent Laid-Open Publication No. 58-116559)

In the above two methods, in order to control charge properties and carrying properties with respect to the toners or to prevent a friction force and so on with respect to the other members such as photo-conductor, layer forming blade, control electrode and so on, a resin coating layer is arranged to a surface of an conductive elastic member.

The present inventors propose by now that the toner carrier utilizing resins such as melamine resin, phenol resin, alkid resin, fluorocarbon resin, polyamide resin, polyurethane resin and so on as the coating layer can improve friction forces and image properties.

However, recently, in order to make a speed of the printer and so on higher or to improve a required image miniaturization or to make a color image and so on, requirements for the image forming properties become severe, and thus various problems which can not be solved by the known toner carrier become obvious. Particularly, a bad image density due to insufficient toner carrying properties or a bad image such as image overlapping due to the bad toner charge properties generated as a result of toner failure by a speeding up becomes a serious problem.

In the known toner carrier, if a ten-point height of irregularities Rz based on JIS on a surface is made larger, the toner carrying properties are improved, but there is a problem such that a generation of image overlapping is made larger. Therefore, a method is proposed such that a friction coefficient of a surface is controlled instead of increasing Rz. However, in the case that the friction coefficient is too small, the toner carrying properties become insufficient and the image density becomes also insufficient. In the case that the friction coefficient is too large, since it is not possible to increase the toner charge to a sufficient level, there are problems such that the image overlapping becomes larger and the toner failure is liable to be generated due to a large friction energy applied to the toners.

Moreover, as to the durability of the toner carrier, problems sometimes occur such that toner agglomerate generated from a filming phenomena due to the toner failure or a sticking member after being melted grinds or wears the toner carrier or contacted parts to the toner member, and a toner leakage is induced.

In order to prevent the toner agglomerate due to the wear of the toner carrier, it is a fundamental solution to prevent a toner filming or a sticking member after being melted. Recently, from the viewpoint of energy saving, there is a design tendency such that a melting point of the toner is shifted downward, and thus it becomes very difficult to solve the above problems. Under such circumstances, as a countermeasure from the toner carrier side, it is very important to take a design concept such that generation factors of the toner agglomerate are eliminated as much as possible.

### DISCLOSURE OF INVENTION

An object of the invention is to provide a conductive roller installed in an image forming apparatus such as a copying machine, a printer and so on, which has excellent toner carrying property and toner charge property, provides a high quality image with no image unevenness and no image overlapping, and has an excellent durability, and the image forming apparatus installing the above conductive roller.

As a result of the inventor's dedicated investigation for achieving the object mentioned above, it is found that the object can be achieved by using the conductive roller, wherein a resin coating layer including a particle having specific hardness and average particle size is arranged on an outer surface of a conductive elastic member arranged around a rotation shaft, as a toner carrier. The present invention can be achieved by such foundation. That is, the present invention is as follows:
(1) A conductive roller comprising a rotation shaft and a conductive elastic layer arranged around the rotation shaft, characterized in that a resin coating layer including a particle having JIS A hardness of 10-99 and an average particle size of 2-30 μm is arranged to an outer surface of the conductive elastic layer;
(2) The conductive roller according to the above (1), wherein the particle having JIS A hardness of 10-99 and an average particle size of 2-30 μm is urethane;
(3) The conductive roller according to the above (1) or (2), wherein, in the resin coating layer, a thickness of the portion in which there is no particle is 4-25 μm;
(4) The conductive roller according to the above (1)-(3), wherein a content of the particle in the resin coating layer is 5-150 parts by weight with respect to 100 parts by weight of a resin component;
(5) The conductive roller according to the above (1)-(4), wherein a surface roughness is 3-20 μm by ten-points height of irregularities Rz based on JIS;
(6) The conductive roller according to the above (1)-(5), wherein a roller resistance is 10³-10¹² Ω;
(7) The conductive roller according to the above (1)-(6), wherein Asker C hardness on the surface is 25-85°;
(8) The conductive roller according to the above (1)-(7), wherein the conductive roller is used as a toner carrier; and
(9) An image forming apparatus comprising a toner carrier and an image forming member wherein a visible image is formed on a surface of the image forming member by supporting a toner thin film on a surface of the toner carrier, contacting or closely approaching the toner carrier to the image forming member and supplying the toner to a surface of the image forming member, characterized in that the conductive roller set forth in the above (1)-(8) is used as the toner carrier.

### BRIEF DESCRIPTION OF DRAWINGS

FIG. 1 is a rough cross sectional view showing one embodiment of a toner carrier according to the invention; and

FIG. 2 is a rough cross sectional view illustrating one embodiment of an image forming apparatus.

### BEST MODE FOR CARRYING OUT THE INVENTION

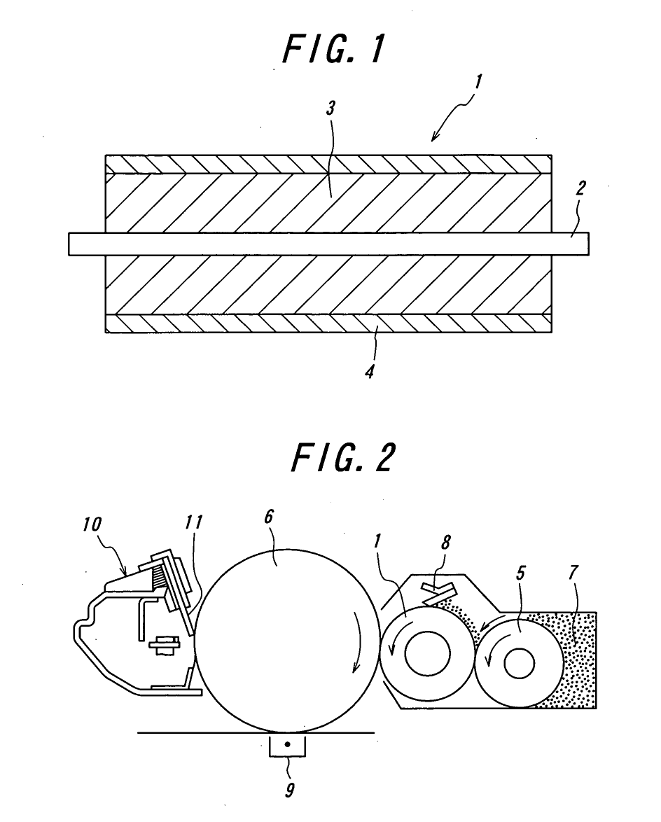

A conductive roller according to the invention is preferably used for a toner carrier and so on, which are installed in an image forming apparatus, and is constructed by a rotation shaft, a conductive elastic layer arranged around the rotation shaft and a resin coating layer arranged on an outer surface of the conductive elastic layer. FIG. 1 is a rough cross sectional view showing one embodiment of the conductive roller according to the invention. In FIG. 1, a conductive roller 1 has a construction such that a conductive elastic layer 3 is arranged to an outer surface of the shaft having a good conductivity, and a resin coating layer 4 is arranged to a surface elastic layer 3.

As the shaft 2 mentioned above, use may be made of any materials if it has a good conductivity. Normally, use is made of a metal shaft such as a metal solid core, a metal cylindrical member with a hollow center and so on.

As the conductive elastic layer mentioned above, use is made of an elastic member wherein conductive agents are added in an appropriate rubber material to show an electric conductivity. The rubber material to be used here is not particularly limited and the following materials may be used one by one or in a combination of two or more materials: nitrile rubber, ethylene-propylene rubber, styrene-butadiene rubber, butadiene rubber, isoprene rubber, natural rubber, silicone rubber, urethane rubber, acrylic rubber, chloroprene rubber, butyl rubber, epichlorohydrin rubber, and so on. In the present invention, among them, it is preferred to use silicone rubber, ethylene-propylene rubber, nitrile rubber, epichlorohydrin rubber and urethane rubber. Moreover, a mixture of the above materials and the other rubber materials is preferably used. Particularly, in the present invention, urethane rubber is most preferably used.

As the conductive agents added in the conductive elastic layer, use is made of ion conductive agents and electron conductive agents. As the ion conductive agents, use is made of ammonium salt such as perchlorate, chlorate, hydrochloride, bromate, iodate, fluorobonate hydracid chloride, hydrosulfate, ethyl hydrosulfate, carboxylate, sulfonic acid chloride, which include tetra ethyl ammonium, tetra butyl ammonium, dodecyl trimethyl ammonium such as lauryl trimethyl ammonium, octadecyl trimethyl ammonium such as stearyl trimethyl ammonium, hexadecyl trimethyl ammonium, benzyl trimethyl ammonium, modified fatty acid dimethyl ethyl ammonium; and perchlorate, chlorate, hydrochloride, bromate, iodate, fluorobonate hydracid chloride, trifluoro methyl, sulfonic acid chloride which include alkali metal or alkali earth metal such as lithium, sodium, calcium, magnesium.

Moreover, as the electron conductive agents, use is made of conductive carbon such as KETJENBLACK, acetylene black; carbon for rubber such as SAF, ISAF, HAF, FEF, GPF, SRF, FT, MT; carbon for ink to which oxidation treatment is applied; thermally decomposed carbon, graphite; conductive metal oxide such as tin oxide, titanium oxide, zinc oxide; metal such as nickel, copper. These conductive agents can be used respectively or in a combined manner of two or more kinds.

Moreover, composition amounts are not particularly limited, but it is preferred in the case of the ion conductive agents to be 0.01-5 parts by weight, more preferably 0.05-2 parts by weight with respect to 100 parts by weight of rubber material, and it is preferred in the case of the electron conductive agents to be 1-50 parts by weight, more preferably 5-40 parts by weight of rubber material.

In the present invention, under the composition amounts mentioned above, a volume resistivity of the conductive elastic layer is controlled preferably in a range of 103-1010-m, more preferably in a range of 10⁴-10⁶ Ω·m.

It should be noted that various additives such as filling agents, cross-linking agents, other additives for rubber may be blended therein other than the conductive agents mentioned above according to need.

The conductive elastic layer mentioned above has preferably a small compression set since it is used in a manner contacting to the image forming member and the layer forming blade. Specifically, as the compression set, it is preferably not more than 20%, more preferably not more than 10%. As the rubber material, it is preferred to use urethane rubber since the compression set can be designed to be small.

In the present invention, a surface roughness of the conductive elastic layer mentioned above is controlled preferably as ten-points height of irregularities Rz based on JIS to be 1-20 μm more preferably 1.5-18 μm. If the ten-points height of irregularities Rz exceeds 20 μm, a surface of the roller becomes hard since it is necessary to make the resin coating layer of the conductive roller thick. As a result, if such roller is used as the toner carrier, the toners are deteriorated and the adhesion of the toners with respect to the image forming member and the layer forming blade occurs, so that the image defect occurs sometimes. On the other hand, if the ten-points height of irregularities Rz is not more than 1 μm, the surface roughness of the roller becomes too small in the case of forming the resin coating layer. As a result, if such roller is used as the toner carrier, the toner carrying property becomes bad, so that the image density becomes sometimes lowered.

In the present invention, the surface roughness mentioned above is determined by using a surface roughness measuring apparatus “SURFCOM 1400D” (TOKYO SEIMITSU CO., LTD.) in such a manner that surface roughness values are measured at more than 300 points evenly in both shaft direction and circumferential direction of the roller under the condition of a measuring length in a direction orthogonal to the shaft direction: 4 mm, a measuring speed: 0.3 mm/sec and a cut-off wavelength: 0.8 mm (hereinafter, the same measuring method is utilized).

In the conductive roller according to the invention, when it is used as the toner carrier, the resin coating layer is arranged to a surface of the conductive elastic layer mentioned above for controlling charge properties and carrying properties with respect to the toners, for reducing friction power between the image forming member and the layer forming blade and for preventing a contamination of the image forming member by means of the conductive elastic layer.

In the present invention, the resin coating layer includes the particles having JIS A hardness of 10-99 and average particle size of 2-30 μm. If the upper ranges of JIS A hardness and average particle size of the particles are exceeded, in the case of using such roller as the toner carrier, it is not possible to obtain the conductive roller in which the carrying properties, the charge properties and the durability of the toners are well balanced in a high level. In this case, it is preferred to set the JIS A hardness of the particles to 40-99 more preferably 50-95, and it is preferred to set the average particle size to 3-25 μm more preferably 4-20 μm.

Further, it is preferred to set an amount of the particles in the resin coating layer to 5-150 parts by weight with respect to 100 parts by weight of the resin components. If the amount of the particles exceeds the upper range, in the case of using such resin coating layer as the toner carrier, it is not possible to obtain the conductive roller in which the carrying properties, the charge properties and the durability of the toners are well balanced in a high level. In this case, it is preferred to set the amount of the particles to 5-100 parts by weight more preferably 5-60 parts by weight.

As the toners mentioned above, use may be made of urethane resin particles such as urethane-urea resin particles and urethane-acryl resin particles. These particles can be used respectively or in a combined manner of two or more kinds.

In the resin coating layer according to the invention, it is possible to add various additives such as charge control agents, lubricants and the other resins for the purpose of an improvement of the charge properties, a reduction of the friction power with respect to the other members and an application of the conductivity.

In the conductive roller according to the invention, it is preferred that a volume resistivity of the resin coating layer mentioned above is made to a value higher than that of the conductive elastic layer for controlling a resistance of the conductive roller. Specifically, it is preferred to set the volume resistivity of the resin coating layer to 10⁷-10¹⁶ Ω·cm more preferably 10⁸-10¹³ Ω·cm. The volume resistivity can be controlled by adding the ion conductive agents and the electron conductive agents in the resin coating layer mentioned above. As the conductive agents, it is possible to use any conductive agents which can utilize in the conductive elastic layer mentioned above.

A method of forming the resin coating layer is not particularly limited. Normally, in order to form the resin coating layer, a coating slurry obtained by dissolving or dispersing resins, cross-linking agents, particles and various additives according to need, which form the coating layer, is prepared, and the thus prepared coating slurry is coated on the conductive elastic layer by means of dipping method, spray method and so on. After that, the coated coating slurry is dried and hardened at a room temperature or at a temperature of 50-170° C.

As a solvent used for preparing the coating slurry, which is used for forming the coating layer mentioned above, use is preferably made of alcohol solvent such as methanol, ethanol, isopropanol, butanol; ketone solvent such as acetone, methyl ethyl ketone, cyclohexane; aromatic hydrocarbons solvent such as toluene, xylene; aliphatic hydrocarbons solvent such as hexane; cyclic aliphatic hydrocarbons solvent such as cyclohexane; esters solvent such as acetic ether; ethers solvent such as isopropyl ether, tetrahydroflan; amide solvent such as dimethyl sulfoamide; halogen hydrocarbons solvent such as chloroform, dichloroethane; or a mixed solvent among them. The solvent mentioned above may be suitably selected in response to a solubility of the resins to be used and is not particularly limited.

In the thus formed coating layer according to the present invention, it is preferred to set a thickness of the portion in which there are no particles to a range of 4-25 μm. If this thickness is less than 4 μm, in the case that the resin coating layer is used as the toner carrier, there is the possibility such that the durability is insufficient and the toner leakage occurs in a short time. On the other hand, if this thickness exceeds 25 μm, the toners are deteriorated so that the toner adhesion to the image forming member and the layer forming blade occurs. Theses phenomena cause the bad image. It is more preferred to set the thickness to 5-22 μm.

It should be noted that the thickness mentioned above is a value determined in such a manner that a cut plane is observed by an actual measurement by means of a stereomicroscope and a portion in which the added particles are not existent is measured. Normally, the particles are exposed to the outer surface or covered with a thin layer.

In the conductive roller according to the invention, it is preferred to set the surface roughness to 3-20 μm shown by the ten-points heights of irregularity Rz based on JIS. If this Rz is less than 3 μm, in the case that the conductive roller is used as the toner carrier, the carrying properties of the toners become bad and there is the possibility such that the image density is decreased. On the other hand, if the Rz exceeds 20 μm, the charge properties of the toners become insufficient and there is the possibility such that the image overlapping occurs. It is more preferred to set the Rz to a range of 4-15 μm.

Moreover, it is preferred to set a resistance of the roller to 10³-10¹² Ω more preferably 10⁴-10¹⁰ Ω. Further, it is preferred to set Asker C hardness on the surface to 35-85°. If the Asker C hardness is less than 35°, in the case that the roller is used as the toner carrier, a friction to the image forming member and the layer forming blade is increased and there is the possibility such that the image deterioration such as jitter occurs. On the other hand, if the Asker C hardness exceeds 85°, a contact area with respect to the image forming member and so on is decreased, and there is the possibility such that an excellent image is not formed. It is more preferred to set the Asker C hardness to 40-80°.

The conductive roller according to the present invention is preferably used as the toner carrier of the developing roller and so on in the image forming apparatus such as the developing apparatus used for the electro-photographic apparatus. For example, as shown in FIG. 2, the image forming apparatus comprises the construction such that the conductive roller according to the invention is provided, as the developing roller 1, between the toner application roller 5 for supplying the toners and the image forming member 6 such as the photosensitive drum for maintaining the electrostatic latent image. Moreover, the toners 7 are supported by the toner application roller 5 and are controlled to an even thin layer by means of the layer forming blade 8. Further, the toners are supplied to the image forming member 6 from the tin layer and are adhered to the electrostatic latent image of the image forming member 6, so that the electrostatic latent image is made visible. In this embodiment, a numeral 9 is a transferring portion, a numeral 10 is a cleaning portion and a numeral 11 is a cleaning blade.

As the image forming apparatus utilizing the conductive roller according to the invention as the toner carrier, use is made of any image forming apparatuses comprising the toner carrier in which the toners are supported thereon to form the toner thin layer and the visible image is formed to the image forming member under such a condition. For example, use may be made of the image forming apparatus in which a paper or an OHP sheet and the like are used as the image forming member and the toners supported on the toner carrier are directly flown thereto through the holes arranged to the control electrode.

As the toners supported by the conductive roller according to the invention, the nonmagnetic mono-component developer is preferably used, but use may be made of the magnetic type mono-component developer. For example, the white/black image is formed by using the magnetic mono-component developer, it is preferred to use the conductive roller and the image forming apparatus according to the invention.

Then, the present invention will be explained in detail with reference to the examples, but the present invention is not limited to those examples.

### EXAMPLE 1

(1) Manufacturing of Conductive Roller

5 parts by weight of 1,4-butanediol, 5 parts by weight of silicone type surface active agent [“BY16-201” manufactured by Dow Corning Toray Co., Ltd.], 0.01 parts by weight of dibutyltin dilaurate and 3 parts by weight of acetylene black were added to and mixed with 100 parts by weight of polyether polyol [“EXCENOL” manufactured by ASAHI GLASS Co., Ltd.]. After that, 17.5 parts by weight of urethane modified MDI [“Sumidur PF” manufactured by Sumika Bayer Urethane Co., Ltd.] was added thereto and the mixture was agitated for two minutes.

Then, the agitated mixture was cast into a metal mold providing a metal shaft having a diameter of 10 mm at its center and preheated at 90° C., and was hardened at 90° C. for 8 hours so as to form a conductive elastic layer to an outer surface of the metal shaft. In this manner, the roller (having a diameter of 22 mm and a length of the conductive elastic layer portion of 230 mm) was obtained.

A surface of the thus obtained roller was ground and was controlled to ten-points height irregularity Rz based on JIS of 8 μm. In this case, the surface roughness was measured by using the surface roughness measuring apparatus “SURFCOM 1400D” (TOKYO SEIMITSU Co., Ltd.) (hereinafter, the same measuring method is utilized).

Then, 10 parts by weight of “Coronate HL” [manufactured by NIPPON POLYURETHANE INDUSTRY CO., LTD.] as a hardening agent, 20 parts by weight of urethane type resin powder “CFB101-40” [manufactured by DAINIPPON INK AND CHEMICALS INCORPORATED, average particle size of 5-10 μm, JIS A hardness of 80], 20 parts by weight of silica powder [“SS20” manufactured by NIPPON SILICA CORPORATION], and 20 parts by weight of carbon black [“2400B” manufactured by MITSUBISHI CHEMICAL CORPORATION] were added to 100 parts by weight of solid component of base polymer [“Nipporan 5120” manufactured by NIPPON POLYURETHANE INDUSTRY CO., LTD., urethane resin type]. In addition, methyl ethyl ketone was added therein as a solvent so as to control a viscosity of the solid component to 5-20 mPa·s. Then, the mixture was agitated by a sand mill so as to obtain a coating slurry for forming the coating layer.

A coating film made of the coating slurry mentioned above was formed to an outer surface of the conductive elastic layer of the roller mentioned above by means of a dipping method, and was hardened by a heat treatment at 110° C. for 4 hours so as to form a resin coating layer having a thickness of 7 μm. In this manner, a conductive roller was manufactured. It should be noted that the thickness mentioned above is a value determined in such a manner that a cut plane is observed by an actual measurement by means of a stereo-microscope and a portion in which the added particles are not existent is measured.

(2) Estimation of Conductive Roller

A resistance, a ten-points height of irregularity Rz based on JIS and an Asker C hardness of the conductive roller obtained according to the above (1) were measured. In addition, durable properties and other properties were measured according to the following methods. The results are shown in Table 1.

<Durable Properties>

A cartridge in which the conductive roller was installed was set in a durability machine which was obtained by reconstructing a lathe, and a continuous rotation was performed at a speed equivalent to a copying machine of 50 sheets/minute under an atmosphere of a temperature of 22° C. and a relative humidity of 55%. After 60 minutes from the start of the continuous rotation, a roller temperature at a toner seal portion was measured by a non-contact type thermometer. If the cartridge was damaged before 60 minutes, a temperature at that time was measured.

Moreover, a white paper was arranged under the durability machine mentioned above, and a time at which the toners start to leak from the durability machine was measured so as to estimate the durable properties. If this time is not less than 500 minutes, it is estimated as acceptable, and if this time is less than 550 minutes, it is estimated as rejectable.

<Other Properties>

A macbeth front edge density and rear edge density were measured as follows. In this case, the macbeth front edge density and rear edge density are not less than 1.2 respectively.

In the macbeth RD918 (reflection density measuring apparatus), a white/black switch was selected, and an ID adjustment was performed by using a calibration plate.

### EXAMPLES 2-5 AND COMPARATIVE EXAMPLES 1-3

In the manufacturing of the conductive roller according to the example 1, the same manufacturing and the same estimation with respect to the conductive roller were performed as it the same as the example 1 except that use was made of the coating slurry for forming the coating layer having the compositions shown in Table 1. The results are shown in Table 1.

TABLE 1-1

| | | | Example | | | |
|---|---|---|---|---|---|---|
| | | | 1 | 2 | 3 | 4 |
| Composition of | base polymer | Nipporan 5120 | 100 | 100 | — | — |
| coating material | | LQ3510 | — | — | 100 | — |
| (parts by weight) | | EAU65B | — | — | — | 100 |
| | hardening agent | Coronate HL | 10 | 10 | 10 | 10 |
| | resin powder | CFB101-40 | 20 | — | 20 | 20 |
| | | RHU5070 | — | 20 | — | — |
| | | RHU230 | — | — | — | — |
| | others | silica powder | 20 | 20 | 20 | 20 |
| | | carbon black | 20 | 20 | 20 | 20 |

| Film thickness of resin coating layer (μm) | | 7 | 8 | 9 | 7 |
|---|---|---|---|---|---|
| Roller property | roller resistance (log Ω) | 5.1 | 4.9 | 4.7 | 5.5 |
| | Rz (μm) | 9.7 | 8.7 | 8.6 | 9.3 |
| | Asker C hardness (degree) | 65 | 65 | 64 | 67 |
| Endurance | temperature of cartridge seal | 50 | 52 | 49 | 51 |
| property | portion (° C.) | | | | |
| | toner leakage [time] (minute) | 600 | 540 | 900 | 540 |
| Other property | macbeth front edge density | 1.38 | 1.39 | 1.41 | 1.35 |
| | macbeth rear edge density | 1.31 | 1.33 | 1.38 | 1.30 |

TABLE 1-2

| | | | | Comparative | | |
|---|---|---|---|---|---|---|
| | | | Example | Example | | |
| | | | 5 | 1 | 2 | 3 |
| Composition of | base polymer | Nipporan 5120 | — | 100 | — | — |
| coating material | | LQ3510 | 100 | — | 100 | 100 |
| (parts by weight) | | EAU65B | — | — | — | — |
| | hardening agent | Coronate HL | 10 | 10 | 10 | 10 |
| | resin powder | CFB101-40 | 20 | — | — | — |
| | | RHU5070 | — | — | — | — |
| | | RHU230 | — | — | — | 20 |
| | others | silica powder | 20 | 20 | 20 | 20 |
| | | carbon black | 20 | 20 | 20 | 20 |

| Film thickness of resin coating layer (μm) | | 20 | 8 | 9 | 7 |
|---|---|---|---|---|---|
| | roller resistance (log Ω) | 5.2 | 4.7 | 4.8 | 5.8 |
| Roller property | Rz (μm) | 7.0 | 9.5 | 8.9 | 14.0 |
| | Asker C hardness (degree) | 68 | 64 | 64 | 65 |
| Endurance | temperature of cartridge seal | 50 | 57 | 58 | 63 |
| property | portion (° C.) | | | | |
| | toner leakage [time] (minute) | 720 | 240 | 300 | 40 |
| Other property | macbeth front edge density | 1.38 | 1.38 | 1.37 | 1.42 |
| | macbeth rear edge density | 1.36 | 1.17 | 1.15 | 1.37 |

(note)
1) Base polymer: parts by weight shows solid component amount.
2) Nipporan 5120: urethane resin type manufactured by NIPPON POLYURETHANE INDUSTRY CO., LTD.
3) LQ3510: polyester urethane type manufactured by Sanyo Chemical Industries, Ltd.
4) EAU65B: acryl urethane type manufactured by Asia Industries, Co., Ltd.
5) Coronate HL: manufactured by NIPPON POLYURETHANE INDUSTRY CO., LTD.
6) CFB101-40: urethane resin type particles manufactured by DAINIPPON INK AND CHEMICALS INCORPORATED, average particle size of 5-10 μm, JIS A hardness of 80.
7) RHU5070: urethane resin type particles manufactured by Dainichiseika Color & Chemical Mfg. Co., Ltd., average particle size of 6-9 μm, JIS A hardness of 85.
8) RHU230: urethane resin type particles manufactured by Dainichiseika Color & Chemical Mfg. Co., Ltd., average particle size of 35-55 μm, JIS A hardness of 85.
9) Silica powder: “SS20” manufactured by NIPPON SILICA CORPORATION.
10) Carbon black: “2400B” manufactured by MITSUBISHI CHEMICAL CORPORATION.

### INDUSTRIAL APPLICABILITY

According to the invention, the conductive roller installed in the image forming apparatus such as a copying machine, a printer and so on, which has excellent toner carrying property and toner charge property, provides a high quality image with no image unevenness and no image overlapping, and has an excellent durability, and the image forming apparatus installing the above conductive roller can be provided.

1. A conductive roller comprising a rotation shaft and a conductive elastic layer arranged around the rotation shaft, characterized in that a resin coating layer including a particle having JIS A hardness of 10-99 and an average particle size of 2-30 μm is arranged to an outer surface of the conductive elastic layer.

2. The conductive roller according to claim 1, wherein the particle having JIS A hardness of 10-99 and an average particle size of 2-30 μm is urethane.

3. The conductive roller according to claim 1, wherein, in the resin coating layer, a thickness of the portion in which there is no particle is 4-25 μm.

4. The conductive roller according to claim 1, wherein a content of the particle in the resin coating layer is 5-150 parts by weight with respect to 100 parts by weight of a resin component.

5. The conductive roller according to claim 1, wherein a surface roughness is 3-20 μm by ten-points height of irregularities Rz based on JIS.

6. The conductive roller according to claim 1, wherein a roller resistance is 10³-10¹² Ω.

7. The conductive roller according to claim 1, wherein Asker C hardness on the surface is 25-85°.

8. The conductive roller according to claim 1, wherein the conductive roller is used as a toner carrier.

9. An image forming apparatus comprising a toner carrier and an image forming member wherein a visible image is formed on a surface of the image forming member by supporting a toner thin film on a surface of the toner carrier, contacting or closely approaching the toner carrier to the image forming member and supplying the toner to a surface of the image forming member, characterized in that the conductive roller set forth in claim 1 is used as the toner carrier.
